(19) United States
(12) Patent Application Publication
(10) Pub. No.: US 2006/0078173 A1
(43) Pub. Date: Apr. 13, 2006

(54) Image processing apparatus, image processing method and image processing program

(75) Inventors: Ayumu Isomura, Tokyo (JP); Ryo Suzuki, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Fuji Photo Film Co., Ltd., Minami-Ashigara-shi (JP)

(21) Appl. No.: 11/247,194

(22) Filed: Oct. 12, 2005

(30) Foreign Application Priority Data
Oct. 13, 2004 (JP) 2004-299160
Oct. 20, 2004 (JP) 2004-305990

(51) Int. Cl. G06K 9/00

(52) U.S. Cl. 382/118

(57) ABSTRACT

The present invention provides an image processing apparatus, comprising: a taken image input section which inputs a taken image in which face portions of persons are recorded; a detection section which detects the face portions of persons; a face selection section which accepts selection of desired face portions from among the detected face portions; an extraction section which extracts face images, which are images of the selected face portions, from the taken image; a template image input section which inputs a template image having composite areas, which are space areas where the extracted face images are to be laid out; and a composite section which lays out the extracted face images on the composite areas of the template image and creates a composite image in which the face images laid out on the composite areas are superimposed on the template image.

### BACKGROUND OF THE INVENTION

1. Field of the Invention

The present invention relates to an image processing apparatus, an image processing method and an image processing program, and in particular to an apparatus, a method and a program for extracting a face portion of a person and superimposing it on a predetermined position on a template image.

2. Description of the Related Art

There have been developed various techniques for easily superimposing a face image, which is an image of a face portion of a person image, with a background image or a clothes image. For example, according to Japanese Patent Application Laid-Open No. 10-222649, two points to be reference points for composite are specified in a background image or a clothes image. Meanwhile, the hair area of a face image and an area surrounded by the facial outline are specified as areas to be used for composite, and two points to be reference points for composite are also specified. The two points on the face image to be reference points for composite should be specified so that they are on a horizontal line running in contact with the tip of the chin, the middle point of the line segment between the two points is at the tip of the chin, and the length of the line segment is corresponding to the horizontal width of the face. Then, the areas to be used for composite are mapped in a manner that the two points specified on the face image and the two points specified on the background image are overlapped with each other to generate a portrait image.

There have been developed various techniques for easily superimposing a face image, which is an image of a face portion of a person image, with a background image or a clothes image. For example, an image processing apparatus according to Japanese Patent Application Laid-Open No. 2004-178163 is provided with an image storage section which stores an input image; a template storage section which stores a template for an area indicating a body portion; a face detection section which detects the position and the size of a face area from an inputted image with the use of a template in the template storage section; decoration information storage section which stores information about decoration having reference points; and an image composite section which scales up/down decoration in accordance with the detected size of a face area, determining positions of the reference points of the scaled-up/scaled-down decoration to fit to the position of the detected face area, and superimposing the enlarged/reduced decoration with the person image.

### SUMMARY OF THE INVENTION

Recently, there has been developed a template image in which face portions of person illustrations are cut out and left as spaces so that a composite image may be generated by inserting face images extracted from an image in which several persons are shown into the space portions, which are composite areas as “holes for faces to be inserted in”.

According to Japanese Patent Application Laid-Open No. 10-222649, when there are recorded multiple persons in a taken image from which face images are to be extracted, it is not possible at all to select which persons' face images are to be superimposed. That is, it is impossible to respond to the need for selecting particular faces of particular persons, such as good friends, from a group photograph and superimposing them with a template.

Furthermore, there may be a case where face images or composite areas are too many or too few because the number of persons recorded in a taken image from which face images are to be extracted is different from the number of composite areas.

In order to prevent this, it is conceivable to prepare in advance multiple template images each of which has a different number of composite areas, for example, ten, eleven or twelve composite areas, select a template having composite areas of the number corresponding to the number of extracted face images, and use it for composite. In this case, however, it is necessary to prepare a template image for each number of composite areas, which will be a great burden. In addition, in order to enable a user to select a template in a different design, it is necessary to prepare a different template even if the number of composite areas is the same, and consequently, the number of required templates will be huge.

If the number of face images is less than the number of composite areas, it is conceivable to lay out face illustrations prepared in advance on excess composite areas. However, if such face illustrations are laid out, face images really photographed and illustrations co-exist, which will give an uncomfortable feeling to those who view it.

Alternatively, if the number of face images is less than the number of composite areas, it is conceivable to lay out particular face images redundantly in excess composite areas to fill the excess composite areas. However, if face images of particular persons are laid out redundantly, it causes unfairness between the particular persons and those whose face images are not laid out redundantly.

An object of the present invention is to make it possible to select desired face image to composite them with a template image with holes for faces to be inserted in.

Another object of the present invention is to make it possible to prepare composite areas of the number corresponding to the number of face image without necessity of preparing a lot of template images.

In order to solve the above-described problems, an image processing apparatus according to the present invention comprises: a taken image input section which inputs a taken image in which face portions of persons are recorded; a detection section which detects the face portions of persons; a face selection section which accepts selection of desired face portions from among the detected face portions; an extraction section which extracts face images, which are images of the selected face portions, from the taken image; a template image input section which inputs a template image having composite areas, which are space areas where the extracted face images are to be laid out; and a composite section which lays out the extracted face images on the composite areas of the template image and creates a composite image in which the face images laid out on the composite areas are superimposed on the template image.

According to this invention, it is possible to create a composite image by accepting selection of any face portions from among face portions detected from a taken image inputted from a digital camera, a recording medium or the like, extracting face images which are images of the selected face portions and superimposing the face images on space portions on a template image with holes for faces to be inserted in. That is, it is possible to provide an interesting image in which face images of particular persons, such as good friends, selected from a group photograph are made a composite image with a template image.

The face selection section may accept selection of desired face portions from a terminal connected via a network. Alternatively, an operation section for accepting an operation input may be further provided, and the face selection section may accept selection of the desired face portions from the operation section.

A taken image selection section which accepts selection of a desired taken image from among the inputted taken images may be further provided, and the detection section may detect face portions from the selected taken image.

An output section which outputs the composite image to a predetermined apparatus may be further provided.

The predetermined apparatus is a terminal connected via a network. Alternatively, the predetermined apparatus is a printer or a media writer.

Furthermore, in order to solve the above-described problems, an image processing method according to the present invention comprises: a taken image input step of inputting a taken image in which face portions of persons are recorded; a detection step of detecting the face portions of persons; a face selection step of accepting selection of desired face portions from among the detected face portions; an extraction step of extracting face images, which are images of the selected face portions, from the taken image; a template image input step of inputting a template image having composite areas, which are space areas where the extracted face images are to be laid out; and a composite step of laying out the extracted face images on the composite areas of the template image and creating a composite image in which the face images laid out on the composite areas are superimposed on the template image.

This image processing method provides the same operation and effect as those of the above-described image processing apparatus.

Furthermore, in order to solve the above-described problems, an image processing program according to the present invention causes a computer to execute: a taken image input step of inputting a taken image in which face portions of persons are recorded; a detection step of detecting the face portions of persons; a face selection step of accepting selection of desired face portions from among the detected face portions; an extraction step of extracting face images, which are images of the selected face portions, from the taken image; a template image input step of inputting a template image having composite areas, which are space areas where the extracted face images are to be laid out; and a composite step of laying out the extracted face images on the composite areas of the template image and creating a composite image in which the face images laid out on the composite areas are superimposed on the template image.

This image processing program provides the same operation and effect as those of the above-described image processing apparatus. This image processing program may be recorded in a CD-ROM, a DVD, an MO or any other computer-readable recording medium and provided.

Furthermore, in order to solve the above-described problems, an image processing apparatus according to the present invention comprises: a taken image input section which inputs a taken image in which face portions of multiple persons are recorded; a detection section which detects the face portions of persons; an extraction section which extracts face images, which are images of the face portions of persons, from the taken image; a layer-for-facial-composite input section which inputs layers for facial composite in which the face images laid out on the composite areas are superimposed on the template image; and a creation section which creates a template image having composite areas of the number corresponding to the total number of the face images by overlapping a part or all of the layers for facial composite.

This image processing apparatus creates a template image having composite areas of the number corresponding to the number of face images extracted from a taken image by overlapping layers for facial composite. That is, it is possible to flexibly create a template image having composite areas, which are holes for faces to be inserted in, according to the number of face images, and prevent unnecessary spaces from being generated on a composite image without necessity of preparing a lot of template images.

The creation section may create a template image by overlapping a background layer in which a background image is laid out with the layers for facial composite as a layer lower than the layers for facial composite. Thereby, it is possible to easily add a desired background image to a template image.

The creation section may lay out and overlap, in accordance with information which specifies positions where layers for facial composite are to be laid out on a background layer, the layers for facial composite on the specified positions on the background layer. Thereby, it is possible to lay out desired composite areas at desired positions.

The creation section may scale up/down the layers for facial composite in accordance with information which specifies the size of the layers for facial composite. Thereby, it is possible to change a composite area to a suitable size to match a background image.

The image processing apparatus may further comprise a composite section which lays out the face images on the composite areas of the template image and superimposes the face images laid out on the composite areas on the template image.

Furthermore, in order to solve the above-described problems, an image processing method according to the present invention comprises: a taken image input step of inputting a taken image in which face portions of multiple persons are recorded; a detection step of detecting the face portions of persons; an extraction step of extracting face images, which are images of the face portions of persons, from the taken image; a layer-for-facial-composite input step of inputting layers for facial composite in which an image for composite having composite areas where the face images are to be superimposed is laid out; and a creation step of creating a template image having composite areas of the number corresponding to the total number of the face images by overlapping a part or all of the layers for facial composite.

This image processing method provides the same operation and effect as those of the above-described image processing apparatus.

Furthermore, in order to solve the above-described problems, an image processing program according to the present invention causes a computer to execute: a taken image input step of inputting a taken image in which face portions of multiple persons are recorded; a detection step of detecting the face portions of persons; an extraction step of extracting face images, which are images of the face portions of persons, from the taken image; a layer-for-facial-composite input step of inputting layers for facial composite in which an image for composite having composite areas where the face images are to be superimposed is laid out; and a creation step of creating a template image having composite areas of the number corresponding to the total number of the face images by overlapping a part or all of the layers for facial composite.

This image processing program provides the same operation and effect as those of the above-described image processing apparatus. This image processing program may be recorded in a CD-ROM, a DVD, an MO or any other computer-readable recording medium and provided.

According to this invention, it is possible to create a composite image by accepting selection of any face portions from among face portions detected from a taken image inputted from a digital camera, a recording medium or the like, extracting face images which are images of the selected face portions and superimposing the face images on space portions on in a template image with holes for faces to be inserted in. That is, it is possible to provide an interesting image in which face images of particular persons, such as good friends, selected from a group photograph are made a composite image with a template image.

Furthermore, according to this invention, a template image having composite areas of the number corresponding to the number of face images extracted from a taken image is created by overlapping layers for facial composite. That is, it is possible to flexibly create a template image having composite areas, which are holes for faces to be inserted in, according to the number of face images, and prevent unnecessary blank from being generated on a composite image without necessity of preparing a lot of template images.

### BRIEF DESCRIPTION OF THE DRAWINGS

FIG. 1 is a schematic functional block diagram of an image processing apparatus according to a first embodiment;

FIG. 2 is an illustration of a concept of information to be stored in taken images DB;

FIG. 3 is an illustration of a concept of information to be stored in the taken images DB;

FIG. 4 shows an example of a template image;

FIG. 5 is a flowchart showing the flow of a composite image provision process;

FIG. 6 shows an example of a taken image;

FIG. 7 shows an example of specification of layout of face portions on composite areas;

FIG. 8 shows an example of a composite image;

FIG. 9 is a schematic functional block diagram of a POS terminal according to a second embodiment;

FIG. 10 is a schematic functional block diagram of an image processing apparatus according to a third embodiment;

FIG. 11 is a flowchart showing the flow of a composite process;

FIG. 12 shows an appearance of a taken image;

FIGS. 13A, 13B and 13C show appearances of layers for facial composite;

FIG. 14 schematically shows overlapping of layers for facial composite and a background layer;

FIG. 15 is an illustration of a concept of layout information;

FIG. 16 shows an example of a template image;

FIG. 17 shows an example of a composite image;

FIG. 18 shows another example of a layer for facial composite;

FIG. 19 shows another example of layout information;

FIG. 20 shows another example of a taken image;

FIG. 21 shows another example of a composite image;

FIG. 22 shows other examples of a layer for facial composite;

FIG. 23 shows an example of image processing information; and

FIG. 24 shows another example of a template image.

### DETAILED DESCRIPTION OF THE PREFERRED EMBODIMENTS

Preferred embodiments of the present invention will be described below with reference to accompanying drawings.

### First Embodiment

[Schematic Configuration]

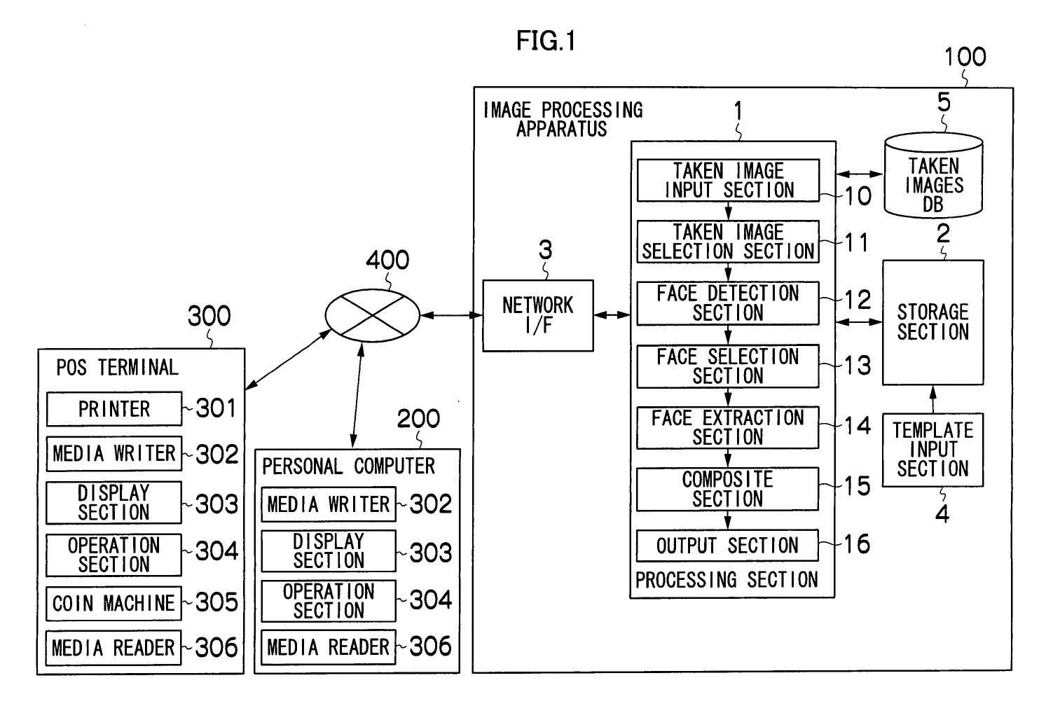

FIG. 1 is a schematic functional block diagram of an image processing apparatus 100 according to a first preferred embodiment of the present invention and a composite photograph provision system utilizing the image processing apparatus. The composite photograph provision system is configured by the image processing apparatus 100, a personal computer 200 and a POS terminal 300 which are connected to one another via a network 400 such as the Internet. Though only one personal computer 200 and only one POS terminal 300 are shown in this figure, multiple personal computers 200 and POS terminals 300 are connected to the image processing apparatus 100 actually. In this case, the image processing apparatus 100 identifies each of the personal computers 200 or the POS terminals 300 by identification information specific to it. That is, the personal computers 200 or the POS terminals 300 are terminals connected to the image processing apparatus 100 in parallel via a network. Hereinafter, the identification information about such a terminal is indicated by a terminal ID. The image processing apparatus 100 may authenticate connection from such a terminal by use of a password in addition to the terminal ID and connect only a terminal for which authentication has been completed. The terminal ID may be information inputted from an operation section 304 of a personal computer 200 or a POS terminal 300 or may be specific information assigned to a terminal in advance such as a network address.

The image processing apparatus 100 has a processing section 1 configured by a CPU or a one-chip microcomputer, a storage section 2 configured by a semiconductor memory, a network I/F 3 for connecting the processing section 1 to a network 400, a template input section 4 configured by any of various data input devices such as a media reader and a USB port, and taken images DB 5 configured by any of various mass storage devices such as a hard disk. The processing section 1 reads a taken image input section 10, a taken image selection section 11, a face detection section 12, a face selection section 13, a face extraction section 14, a composite section 15 and an output section 16, which are programs stored in the storage section 2, from the storage section 2 and executes them as appropriate. The taken image input section 10 inputs a taken image which has been digitally recorded by a digital still camera or a film scanner, from the personal computer 200 or the POS terminal 300 via the network 400 and the network I/F 3. The taken image input section 10 can be realized by a file upload function of an FTP (File Transfer Protocol) server and the like. The taken image which has been inputted is stored in the taken images DB 5 in association with an image ID, which is information uniquely identifying the image.

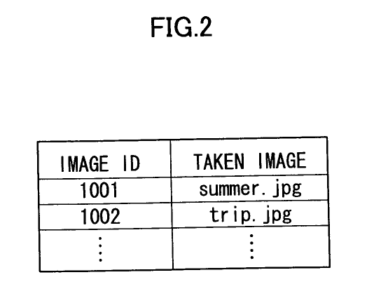

FIG. 2 is an illustration of a concept of information to be stored in the taken images DB 5. As shown in this figure, an image ID and a taken image is stored in association with each other in the taken images DB 5. The image ID may be any unique information, and the filename of a taken image may be used as the image ID if it is unique.

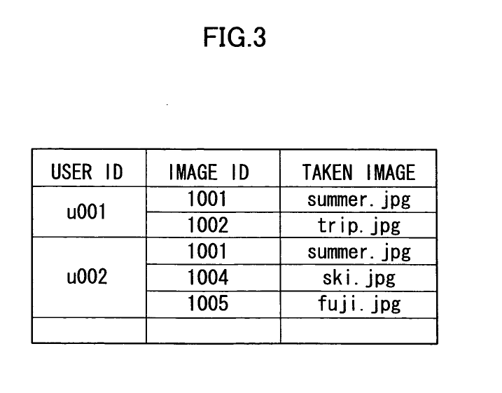

The taken image selection section 11 accepts selection of a desired taken image from among taken images stored in the taken images DB 5, from the personal computer 200 or the POS terminal 300. The selected taken image is stored in the storage section 2. Selectable images may be limited according to users operating the personal computer 200 or the POS terminal 300. In this case, a user ID, which is identification information about a user, an image ID and a taken image are stored in association with one another in the taken images DB 5 as shown in FIG. 3, and the taken image selection section 11 enables a desired taken image to be selected from among taken images corresponding to the user ID of the user operating the personal computer 200 or the POS terminal 300. By associating the same image ID (for example, an image ID “I001” in FIG. 3) with user ID's (for example, user ID's “u001” and “u002” in FIG. 3) assigned to users belonging to a particular group, such as school classmates, event participants and tour participants, members belonging to the same group can select the same taken image.

The face detection section 12 detects a face portion of a person from a taken image stored in the storage section 2 by use of a well-known face recognition technique. If there are recorded multiple persons in the taken image, multiple face portions are individually detected. The detected face portions are stored in the storage section 2.

The face selection section 13 accepts selection of a desired face portion from among the detected face portions, from the personal computer 200 or the POS terminal 300. The face extraction section 14 extracts a face image which is an image of the face portion the selection of which has been accepted by the face selection section 13, from the taken image. The extracted face image is stored in the storage section 2.

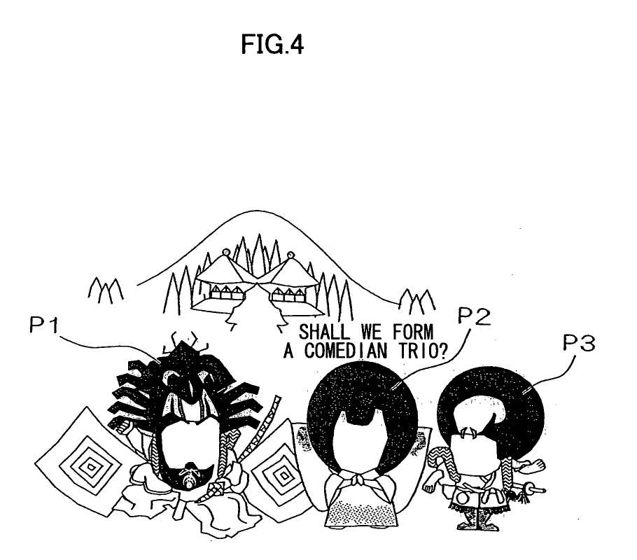

The template input section 4 is configured by a media reader or a USB port and accepts input of a template image from a CD-R or the like. As shown in FIG. 4, a template image has composite areas (in this figure, Pn: n=1 to 3), which are space areas provided as holes for face images to be inserted in, for composite of the face images. The form and the number of the composite areas and the illustration of the template image are not limited to those shown in the figure.

The composite section 15 creates a composite image by laying out face images in the storage section 2 on composite areas on a template image and superimposing the images at the composite areas. The composite image which has been created may be stored in the storage section 2 or may be stored in the taken images DB 5 in association with a user ID identifying a personal computer 200 or a POS terminal 300 which has selected the taken image and the face portions. The output section 16 sends the composite image which has been created to the personal computer 200 or the POS terminal 300 via the network 400.

The POS terminal 300 is a terminal for accepting a print order of a taken image or a composite image for profit and performing printing, and has a printer 301 for printing a composite image sent from the output section 16 or a taken image, a media writer 302 for writing a composite image to a predetermined storage medium such as a CD-R, a display section 303 configured by a liquid crystal display, an operation section 304 configured by a touch panel or a pointing device, a coin machine 305 for performing cash settlement for a fee for print order, a media reader 306 for reading a taken image from various recording media such as a CD-ROM and a compact flash, and the like. Similarly, the personal computer 200 also has a media writer 302, a display section 303, an operation section 304 and a media reader 306. In order to sell a print of a composite image for cash, it is possible to enable selection of a taken image and selection of face portions only from the POS terminal 300 and enable only input of a taken image from the personal computer 200. The image processing apparatus 100 or the personal computer 200 may be connected to the printer 301 for printing a composite image or may have the media writer 302 for storing a composite image in a predetermined storage medium.

[Process Flow]

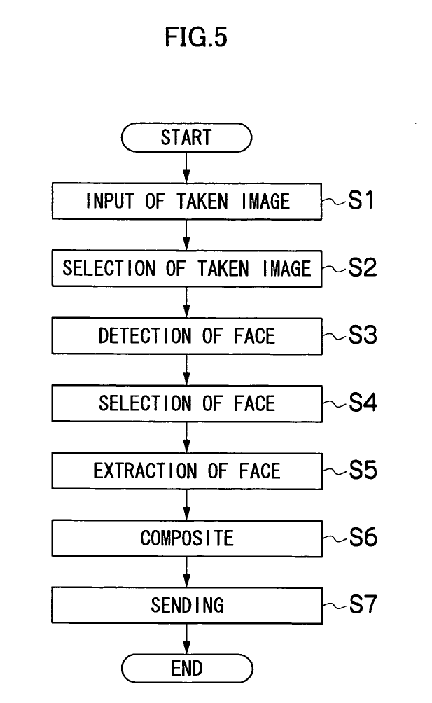

Next, the flow of a composite image provision process to be performed by the image processing apparatus 100 will be described based on the flowchart in FIG. 5.

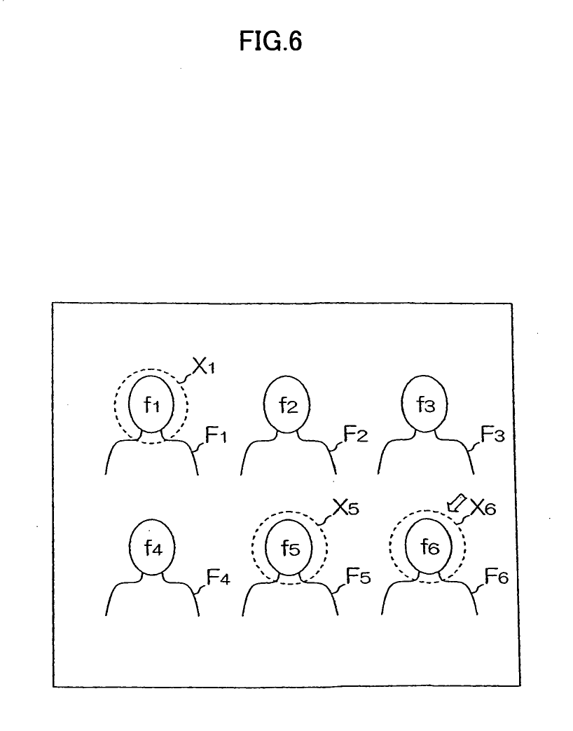

At S1, the taken image input section 10 inputs a taken image from the media reader 306 of a personal computer 200 or a POS terminal 300 via the network 400. FIG. 6 shows an example of a taken image to be inputted into the taken image input section 10. There are recorded multiple persons Fn (here, n=1 to 6) in the taken image, as a group photograph. The object of a taken image to be inputted is not especially limited though the taken image is required to include multiple persons. The taken image input section 10 gives a unique image ID to the taken image which has been inputted and stores the image ID and the taken image in the taken images DB 5 in association with each other.

At S2, the taken image selection section 11 accepts selection of a desired taken image from among taken images stored in the taken images DB 5, from the operation section 304 of a personal computer 200 or a POS terminal 300. The personal computer 200 or the POS terminal 300 which inputs a taken image and the personal computer 200 or the POS terminal 300 which selects a taken image do not have to be related to each other. However, it is possible to impose a restriction that a desired taken image is to be selected from taken images corresponding to the user ID assigned to a user who uses the personal computer 200 or the POS terminal 300 to select a taken image, as described above.

At S3, the face detection section 12 detects face portions of persons from the selected taken image. In FIG. 6, face portions f1 to f6 of the six persons F1 to F6 have been detected. The result of detection of the face portions is converted to data which can be viewed on a personal computer 200 or a POS terminal 300, such as a Web page, and sent to the personal computer 200 or the POS terminal 300 by the output section 16, and the data is displayed on the display section 303.

At S4, the face selection section 13 accepts selection of desired face portions from among the detected face portions, from the operation section 304 of the personal computer 200 or the POS terminal 300. The selection result is displayed on the display section 303. In FIG. 6, the face portions f1, f5 and f6 have been selected. Marks X1, X5 and X6 are displayed around the selected face portions, and thereby, which face portions are selected can be checked from the display section 303 of the personal computer 200 or the POS terminal 300.

At S5, the face extraction section 14 extracts (trimming) the face images, which are images of the face portions the selection of which have been accepted by the face selection section 13, from the taken image.

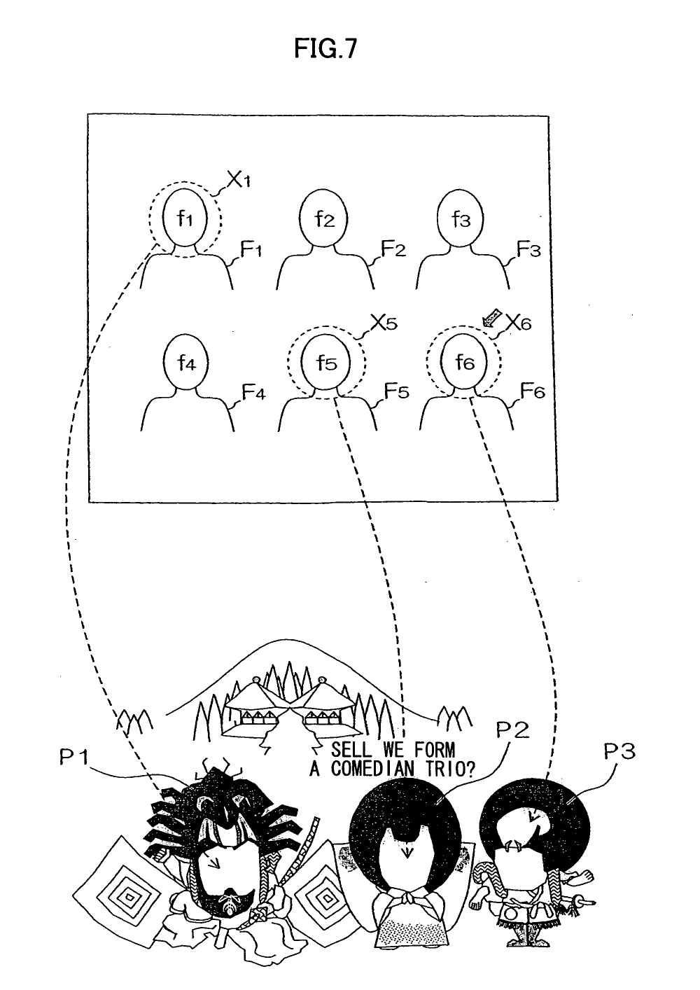

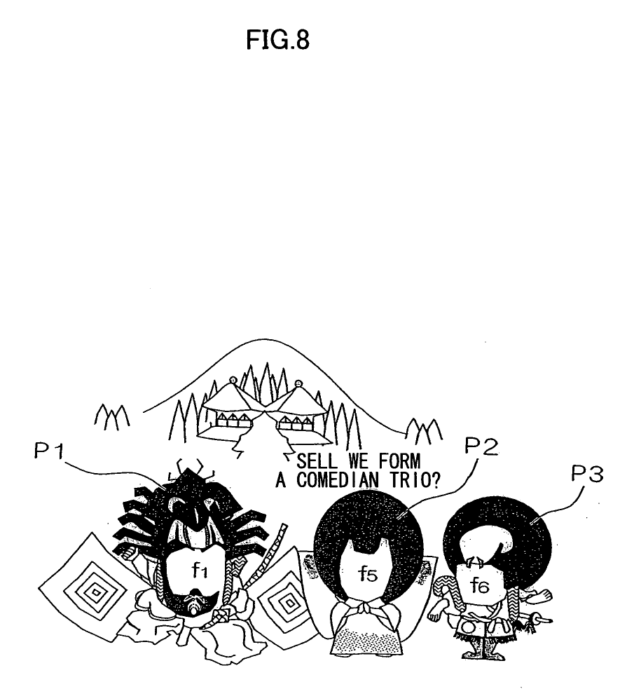

At S6, the extracted face images are laid out on composite areas on a template image and superimposed on the template image. Which face images should be laid out on which composite areas is arbitrarily determined. They may be randomly laid out, or the layout may be specified from the operation section 304 of the personal computer 200 or the POS terminal 300. For example, as shown in FIG. 7, the positions where face images are to be laid out may be specified by drag-and-dropping the face portions selected by the operation section 304 to desired composite positions. FIG. 8 conceptually shows that the face portions f1, f5 and f6 are laid out on composite areas P1 to P3, respectively, and composite.

At S7, the output section 16 sends the composite image which has been created to the personal computer 200 or the POS terminal 300 via the network 400. The POS terminal 300 performs settlement for a fee for printing the composite image by use of the coin machine 305, and then prints the composite image sent from the output section 16 by use of the printer 301. The taken image inputted into the taken image input section 10 may also be printed by use of the printer 301 to provide the taken image and the composite images as a set. The composite image sent from the output section 16 may be recorded on any of various recording media, such as a CD-R, set in the media writer 302 simultaneously when the composite image is printed or at a different time.

A program for causing the processing section 1 to execute the above-described steps S1 to S7, that is, a program for causing the processing section 1 to function as the taken image input section 10, the taken image selection section 11, the face detection section 12, the face selection section 13, the face extraction section 14, the composite section 15 and the output section 16 is stored in the storage section 2. This program may be recorded in any of various computer-readable recording media such as a CD-ROM and provided for profit or for free, or may be provided via a network.

As described above, it is possible to input any taken images from the personal computer 200 or the POS terminal 300 to accumulate them in the taken images DB 5, accept selection of any taken image from among such accumulated taken images, detect face portions from the taken image which has been selected, accept selection of desired face portions from among the detected face portions, extract images of the selected face portions to create a composite image in which the images are superimposed on space portions on a template with holes for faces to be inserted in, and send the composite image to the personal computer 200 or the POS terminal 300. That is, it is possible to provide an interesting image in which face images of particular persons, such as good friends, selected from a group photograph are made a composite image with a template image.

### Second Embodiment

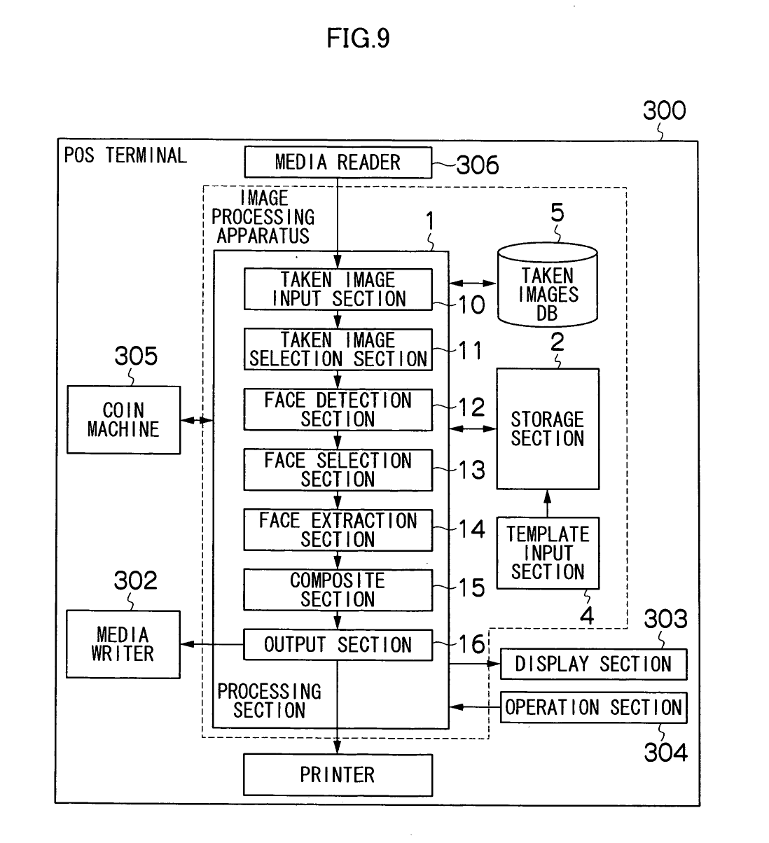

The image processing apparatus 100 may be included in a POS terminal 300. In this case, the POS terminal 300 according to this embodiment is in a configuration that the printer 301 and the media writer 302 are connected to the output section 16 of the image processing apparatus 100 of the first embodiment, as shown in FIG. 9, and a composite image is outputted to the printer 301 or the media writer 302 not via a network but directly. Furthermore, the POS terminal 300 according to this embodiment is in a configuration that the media reader 306 is connected to the taken image input section 10 of the image processing apparatus 100 of the first embodiment, and a taken image is inputted to the taken image input section 10 not via a network but directly. Furthermore, in the POS terminal 300 according to this embodiment, the display section 303, the operation section 304 and the coin machine 305 are connected to the processing section 1 of the image processing apparatus 100 of the first embodiment, and the function of each section and the process to be performed by the processing section 1 are similar to those of the first embodiment. The POS terminal 300 may or may not have the network I/F 3. This POS terminal 300 may select face portions and provide a composite image not via the network 400 but as a stand-alone.

### Third Embodiment

A third preferred embodiment of the present invention will be described below with reference to accompanying drawings.

[Schematic Configuration]

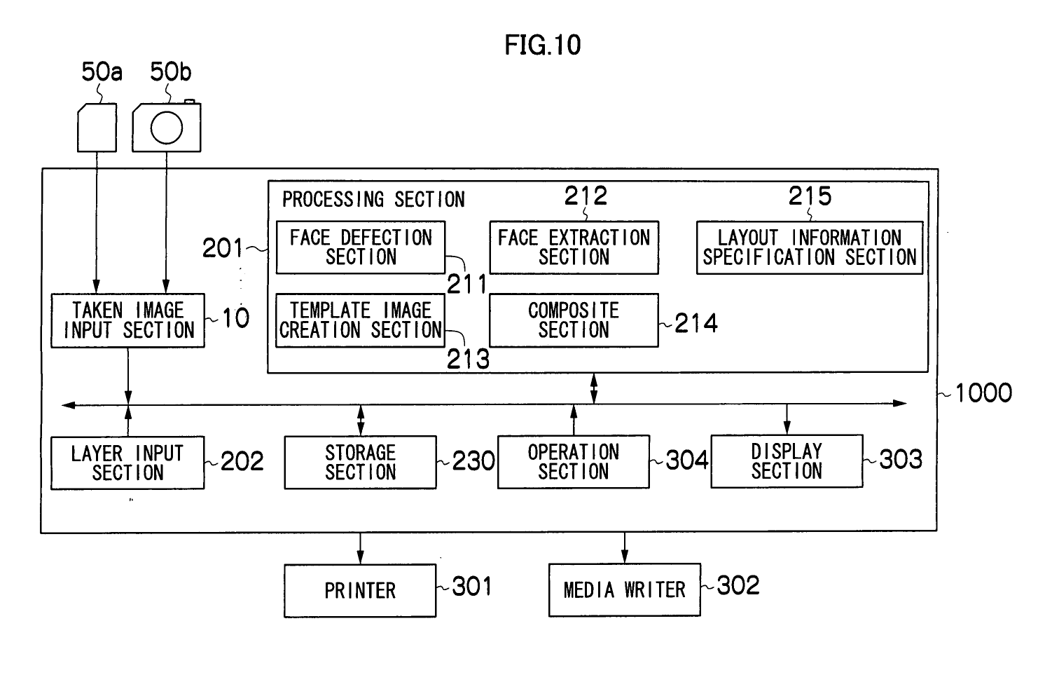

FIG. 10 is a schematic functional block diagram of an image processing apparatus 1000 according to a preferred embodiment of the present invention. The image processing apparatus 1000 has a taken image input section 10, an operation section 304, a display section 303, a processing section 201 and a storage section 230. The taken image input section 10 inputs a taken image from any of various recording media 50a such as a compact flash, a digital still camera 50b, a film scanner or the like. The processing section 201 is configured by a CPU, a one-chip microcomputer or the like. A face detection section 211, a face extraction section 212, a template image creation section 213, a composite section 214 and a layout information specification section 215 are programs stored in the storage section 230, which are loaded on the processing section 201 and executed. The operation section 304 is configured by a pointing device, a keyboard, a touch panel or the like for accepting input of a user operation.

The face detection section 211 detects a face portion of a person from a taken image by use of a well-known face recognition technique. If there are recorded multiple persons in the taken image, multiple face portions are individually detected. The face extraction section 212 extracts face images which are images of the detected face portions of persons, from the taken image.

A layer input section 202 inputs a layer for facial composite on which an image for composite having space composite areas where face images are to be superimposed, that is, holes for faces to be inserted in is laid out. The template image creation section 213 overlaps a part or all of layers for facial composite inputted by the layer input section 202 to create a template image having composite areas of the number corresponding to the total number of extracted face images. The created template image is outputted to the composite section 214. The details of creation of a template image will be described later. The composite section 214 creates a composite image by laying out face images extracted by the face extraction section 212 on composite areas on the template image and superimposing the face images with the template image.

The display section 303 is configured by a liquid crystal display and displays a composite image or a face image. The image processing apparatus 1000 may be connected to the printer 301 for printing a composite image or the media writer 302 for storing a composite image in various storage media such as a CD-R.

[Process Flow]

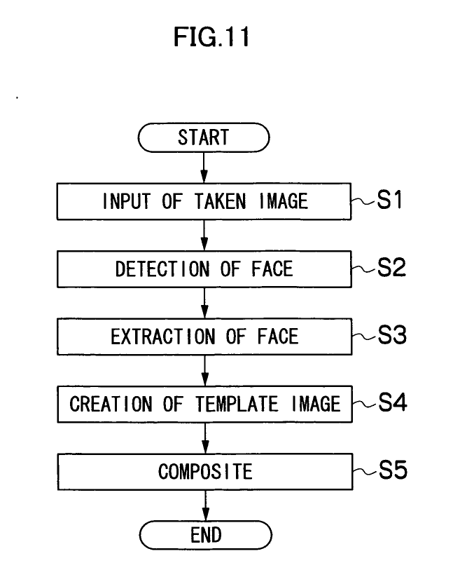

Next, the flow of a composite process to be performed by the image processing apparatus 1000 will be described based on the flowchart in FIG. 11.

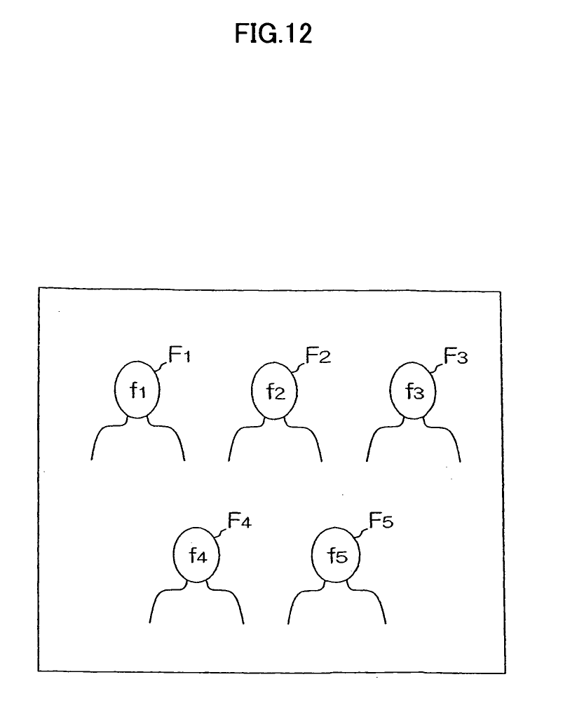

At S11, the taken image input section 10 inputs a taken image. FIG. 12 shows an example of a taken image to be inputted into the taken image input section 10. In the taken image, there are recorded multiple persons Fn (here, n=1 to 5). The content of a taken image to be inputted is not especially limited except that faces of persons should be recorded clearly.

At S12, the face detection section 211 detects face portions of persons from the taken image. For example, face portions fn of persons Fn are detected in the taken image shown in FIG. 12.

At S13, the face extraction section 212 extracts face images which are images of the detected face portions of persons, from each taken image. The face image corresponding to each face portion is designated by the same reference characters fn.

At S14, the template image creation section 213 overlaps a part or all of the layers for facial composite inputted by the layer input section 202 to create a template image having composite areas of the number corresponding to the total number of extracted face images.

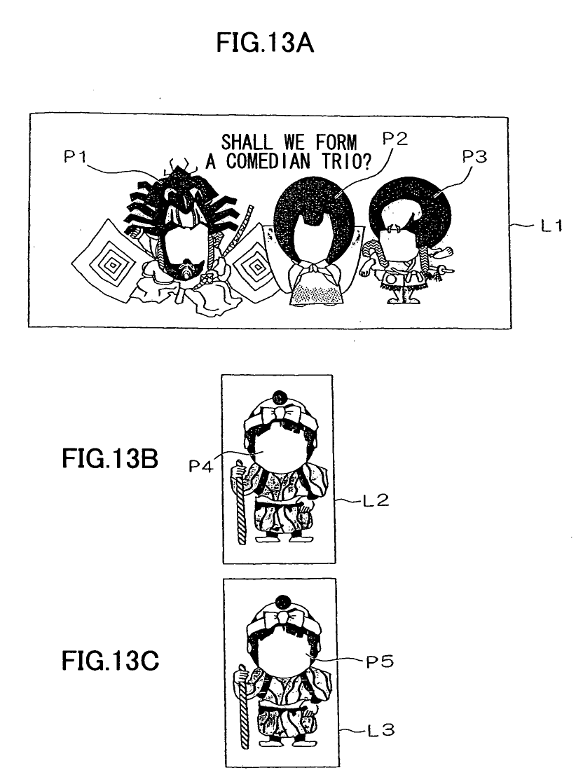

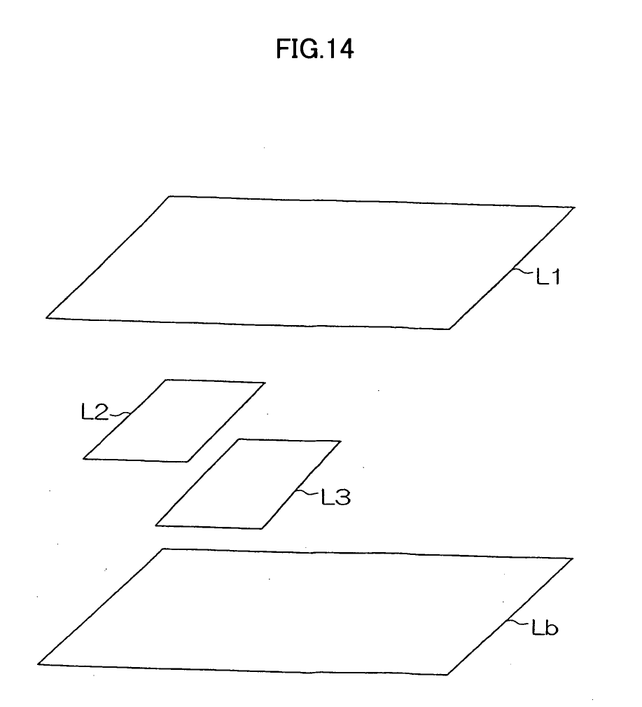

For example, if five face images are extracted from the taken image in FIG. 12, a template image having five composite areas is required. In this case, the template image creation section 213 selects a layer for facial composite L1 having three composite areas P1 to P3 shown in FIG. 13A, a layer for facial composite L2 having one composite area P2 shown in FIG. 13B and a layer for facial composite L3 having one composite area P3 shown in FIG. 13C, from among the layers for facial composite inputted by the layer input section 202. The template image creation section 213 then overlaps the selected layers for facial composite L1 to L3 to create a template image having five composite areas P1 to P5 as shown in FIG. 14. Alternatively, if two face images are extracted from a taken image, the layers for facial composite L2 and L3 are overlapped to create a template image having the composite areas P4 and P5, though this is not shown.

The template image creation section 213 selects and overlaps a part or all of layers for facial composite inputted by the layer input section 202 according to the number of face images. It may directly use one layer for facial composite as a template image. For example, in the case of three face images, the layer for facial composite L1 having three composite areas P1 to P3 is directly used as a template image.

In order to add a desired background image to a template image, it is possible to input a background layer Lb having the background image from the layer input section 202 and overlap layers for facial composite selected by the template image creation section 213 with the background layer Lb. In this case, it is favorable to add the background layer Lb as the lowest layer to prevent composite areas of the layers for facial composite from being invisible due to the background image (see FIG. 14). It is also possible to specify a desired background layer Lb to be overlapped from the operation section 304 from among background layers inputted by the layer input section 202 and overlap the specified background layer Lb with layers for facial composite. Thereby, it is possible to easily change only the background image without changing composite areas.

Furthermore, it is also possible to specify layout of layers for facial composite so that composite areas can be laid out at appropriate positions on a background. That is, it is possible to store layout information which specifies layout of composite areas of layers for facial composite on a background layer Lb, in the storage section 230 in advance, and overlap the background layer and the layers for facial composite in a manner that the composite areas of the layers for facial composite are laid out at the composite areas positions specified in accordance with the layout information.

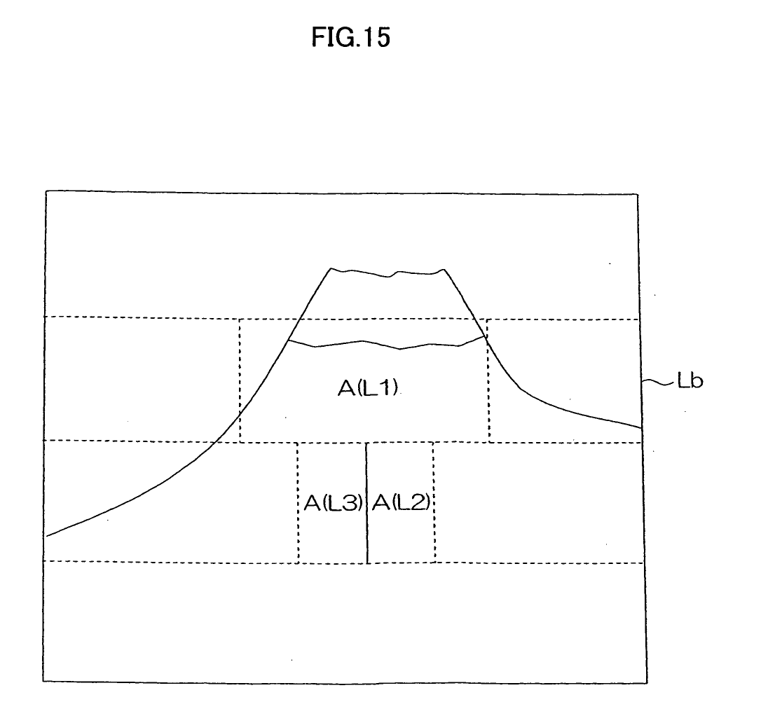

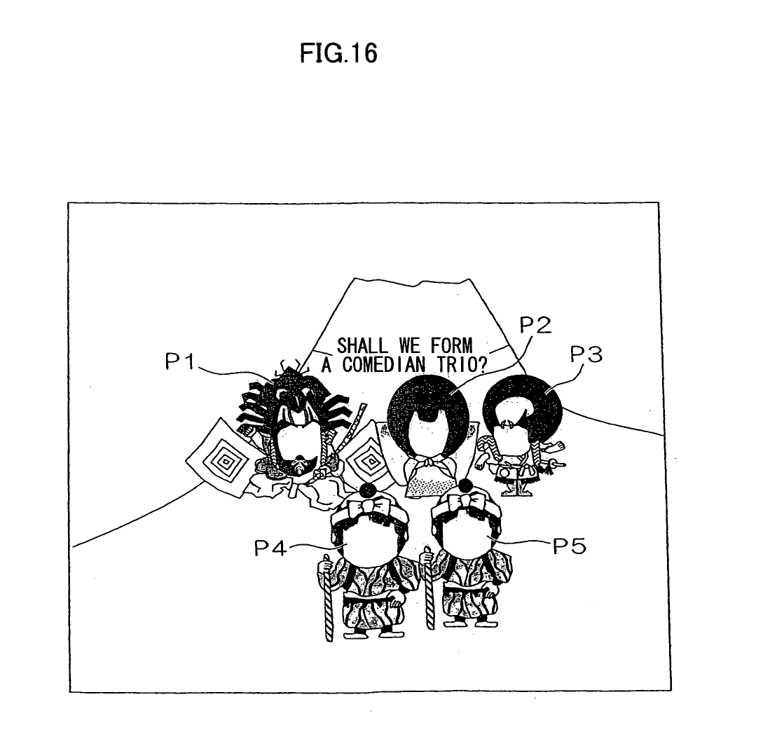

FIG. 15 is an illustration of a concept of layout information. In this figure, layout information A(L1) to A(L3) indicating the layers for facial composite L1 to L3, respectively, are shown in rectangles. The layers for facial composite are laid out so that they are inserted in the rectangles, in accordance with the layout information. The layout information can be created and changed in accordance with desired layout positions accepted by the layout information specification section 215 from the operation section 304. When the layout information specification section 215 accepts specification of a desired layout position of each layer for facial composite, it is stored in the storage section 230 as layout information. FIG. 16 is an example of a template image which has been created based on the background layer Lb, the layers for facial composite L1 to L3, the layout information A(L1) to A(L3).

In some cases, all of layers for facial composite may not be overlapped as described above, and the template image creation section 213 ignores layout information about such a layer for facial composite which is not to be overlapped. For example, in the case of directly using the layer for facial composite L1 as a template image, the template image creation section 213 refers only to the layout information A(L1) about the layer for facial composite L1 and ignores the layout information A(L2) and A(L3) about the layers for facial composite L2 and L3.

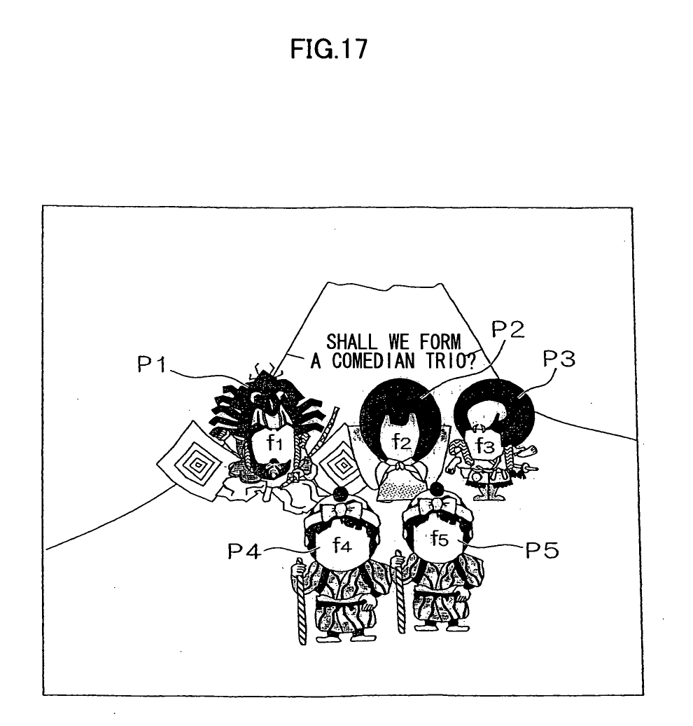

At S15, the composite section 214 lays out the face images fn on composite areas Pn on the template image and superimposes the face images fn on the template image. The composite section 214 may perform image processing, such as scaling up/down, change in aspect ratio, centering and change in colors, for the face images fn as appropriate before composite so that the face images fn can be appropriately superimposed on the composite areas Pn. FIG. 17 shows an example of a composite image.

An image processing program for causing the processing section 201 to execute the steps S11 to S15 and function as the face detection section 211, the face extraction section 212, the template image creation section 213, the composite section 214 and the layout information specification section 215 is stored in the storage section 230. The image processing program may be recorded in a CD-ROM, a DVD, an MO or any other computer-readable recording medium and provided for the processing section 201.

As described above, the image processing apparatus 1000 creates a template image having composite areas of the number corresponding to the number of face images extracted from a taken image by overlapping layers for facial composite, lays out the face images on the composite areas of the created template image and superimposes the face images on the composite areas to obtain a composite image. That is, it is possible to flexibly create a template image having composite areas, which are holes for faces to be inserted in, according to the number of face images extracted from a taken image, and prevent unnecessary spaces from being generated on a composite image without necessity of preparing a lot of template images.

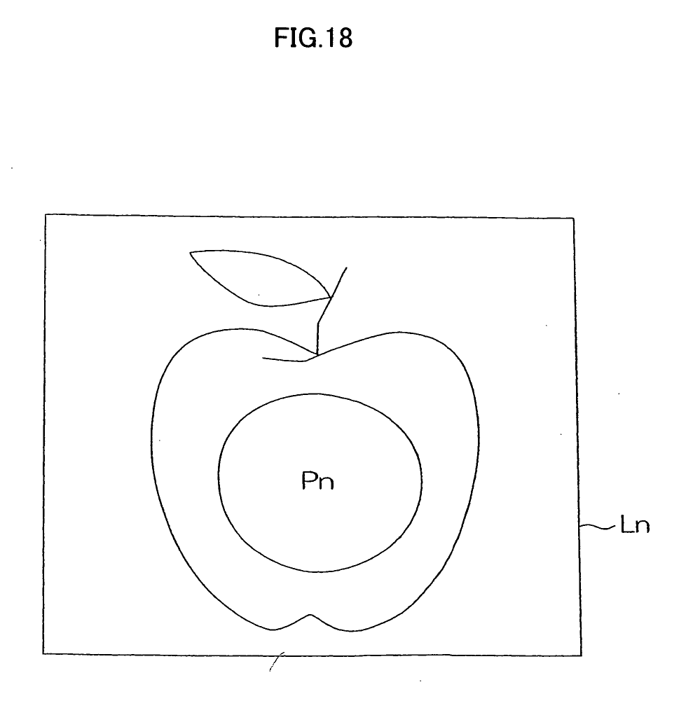

The form and the number of composite areas on a layer for facial composite and the illustration on an image for composite are not limited to those described above. For example, the form and the illustration may be the same for composite areas Pn of multiple layers for facial composite Ln (n=1, 2 . . . ), as shown in FIG. 18. If the composite areas Pn are uniformed, it is convenient when a lot of face images are superimposed. That is, if the illustration of the composite areas Pn are uniformed, it is not necessary to consider uniformity in design among different composite areas (for example, between the layer for facial composite L1 and the other layers for facial composite L2 and L3 in FIG. 13A-C) and only uniformity with a background image has to be considered. Therefore, specification of layout information is simplified.

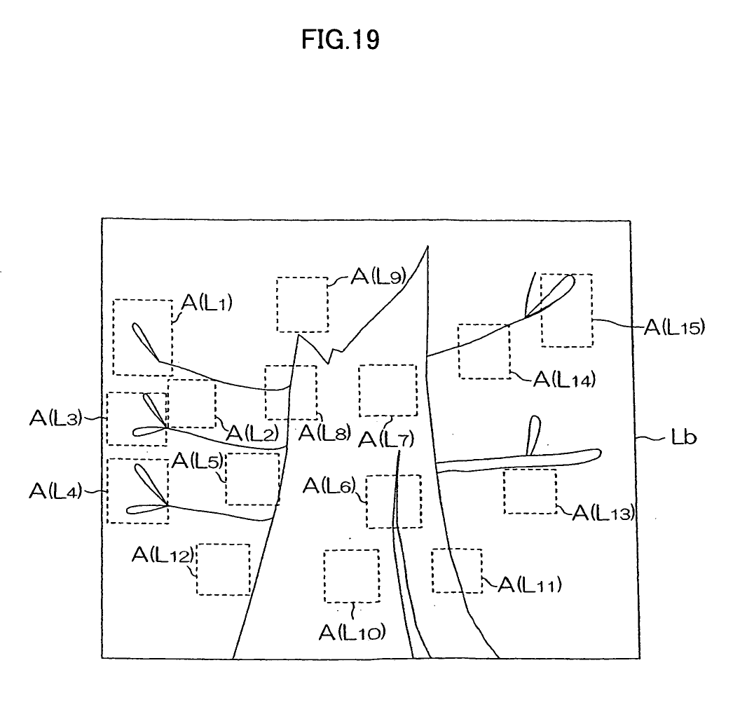

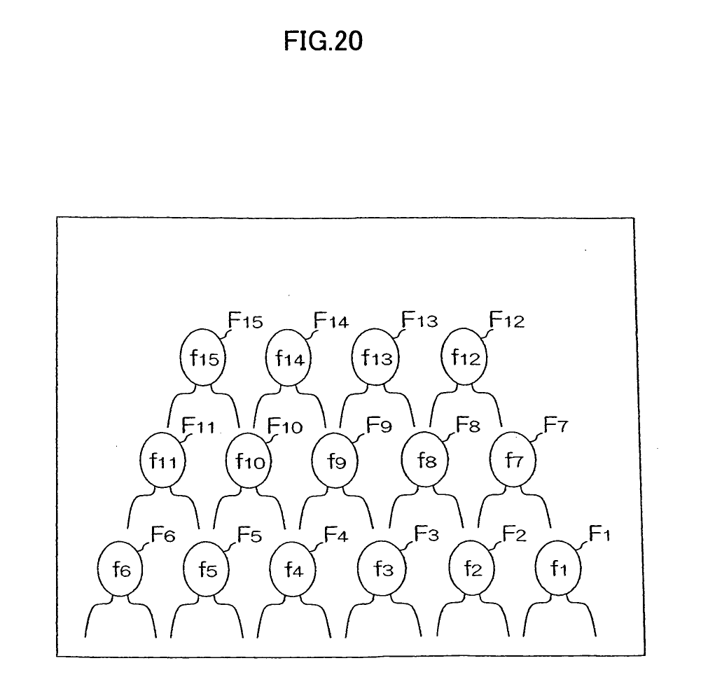

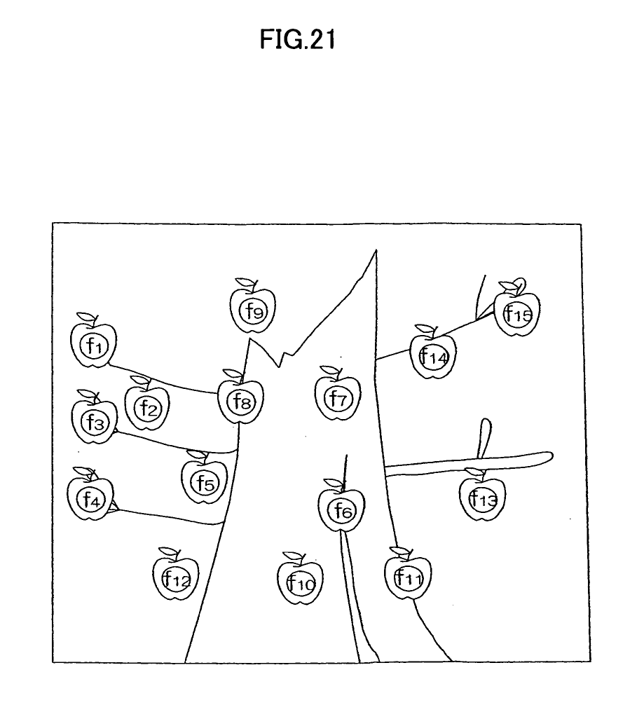

For example, it is sufficient to specify the layout position of each layer for facial composite Ln in a manner that a fruit illustration for the composite area Pn matches a tree illustration of a background layer Lb, as shown in FIG. 19, and therefore, it is possible to easily lay out a lot of composite areas Pn on the background layer Lb. If it is assumed that a taken image in which fifteen persons F1 to F15 are recorded as shown in FIG. 20 is inputted into the taken image input section 10, then it is possible to obtain an interesting composite image in which a lot of face images are laid out on composite areas by laying out face images f1 to f15 on composite areas Pn and superimposing the face images f1 to f15 with the composite areas Pn (see FIG. 21).

The template image creation section 213 may perform image processing, such as scaling up/down, change in aspect ratio and centering, for the layers for facial composite Ln before overlapping so that the layers for facial composite Ln match the form and the size of the background of the background layer Lb. Specifically, the layout information specification section 215 accepts specification of image processing information, such as change in the size or change in the form, for each of the layers for facial composite Ln from the operation section 304. The template image creation section 213 performs image processing for the layers for facial composite Ln based on the image processing information, and then overlaps the layers for facial composite Ln and the layer Lb in accordance with the layout information A(Ln).

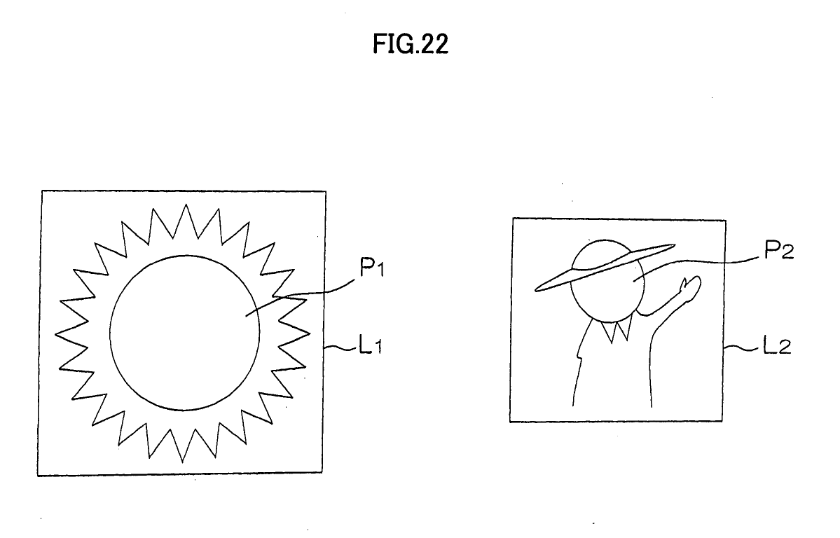

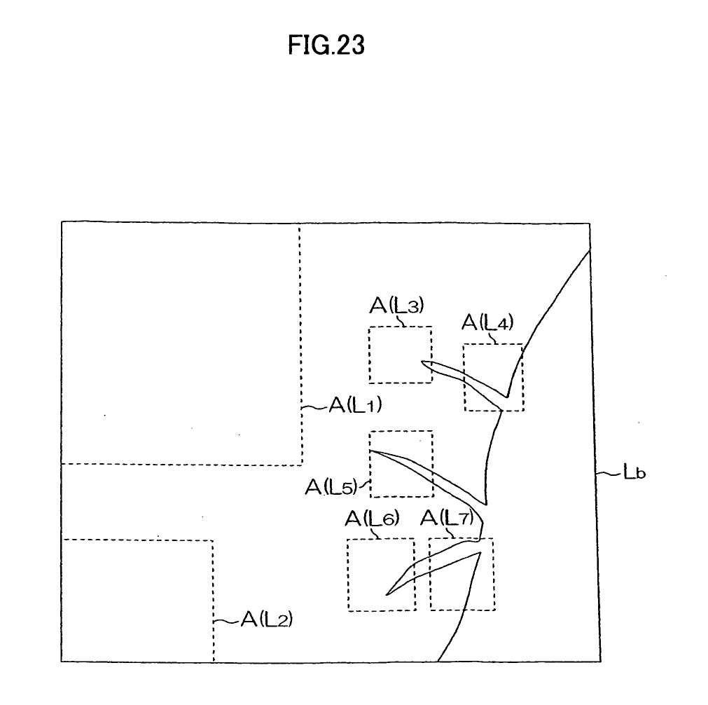

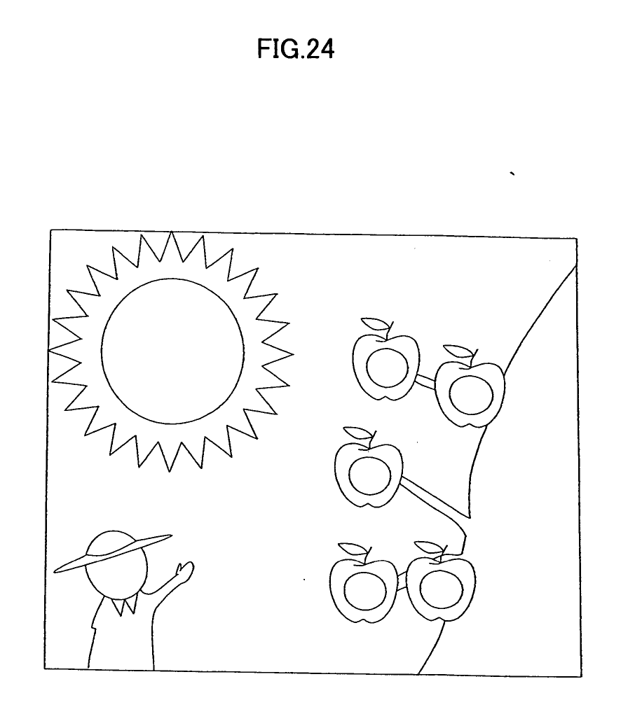

For example, as shown in FIG. 22, layers for facial composite L1 and L2 are created in different designs, and other layers for facial composite Ln (n=3, 4, . . . ) are assumed to be similar to those in FIG. 18. Meanwhile, image processing information indicates the forms and the sizes of areas A(Ln) in which the layers for facial composite Ln are to be inserted, as shown in FIG. 23. This image processing information also specifies layout of the layers for facial composite Ln and is also used as layout information. The template image creation section 213 performs various image processing, such as scaling up/down, change in aspect ratio and trimming, for the layers for facial composite Ln so that the forms and the sizes may match the specified areas A(Ln) of the background layer Lb, and then lays out and overlaps the layers for facial composite Ln on the specified areas A(Ln) of the background layer Lb. FIG. 24 shows an appearance of a template image obtained as a result. Accordingly, it is possible to appropriately change the size and the form of layers for facial composite in various designs so that they may match a background image before overlapping.

What is claimed is:

1. An image processing apparatus, comprising:
a taken image input section which inputs a taken image in which face portions of persons are recorded;
a detection section which detects the face portions of persons;
a face selection section which accepts selection of desired face portions from among the detected face portions;
an extraction section which extracts face images, which are images of the selected face portions, from the taken image;
a template image input section which inputs a template image having composite areas, which are space areas where the extracted face images are to be laid out; and
a composite section which lays out the extracted face images on the composite areas of the template image and creates a composite image in which the face images laid out on the composite areas are superimposed on the template image.

2. The image processing apparatus according to claim 1, wherein the face selection section accepts selection of the desired face portions from a terminal connected via a network.

3. The image processing apparatus according to claim 1, further comprising an operation section which accepts an operation input, wherein the face selection section accepts selection of the desired face portions from the operation section.

4. The image processing apparatus according to claim 1, further comprising a taken image selection section which accepts selection of a desired taken image from among the inputted taken images, wherein the detection section detects face portions from the selected taken image.

5. The image processing apparatus according to claim 2, further comprising a taken image selection section which accepts selection of a desired taken image from among the inputted taken images, wherein the detection section detects face portions from the selected taken image.

6. The image processing apparatus according to claim 3, further comprising a taken image selection section which accepts selection of a desired taken image from among the inputted taken images, wherein the detection section detects face portions from the selected taken image.

7. The image processing apparatus according to claim 1, further comprising an output section which outputs the composite image to a predetermined apparatus.

8. The image processing apparatus according to claim 7, wherein the predetermined apparatus is a terminal connected via a network.

9. The image processing apparatus according to claim 7, wherein the predetermined apparatus is a printer or a media writer.

10. An image processing method, comprising:
a taken image input step of inputting a taken image in which face portions of persons are recorded;
a detection step of detecting the face portions of persons;
a face selection step of accepting selection of desired face portions from among the detected face portions;
an extraction step of extracting face images, which are images of the selected face portions, from the taken image;
a template image input step of inputting a template image having composite areas, which are space areas where the extracted face images are to be laid out; and
a composite step of laying out the extracted face images on the composite areas of the template image and creating a composite image in which the face images laid out on the composite areas are superimposed on the template image.

11. An image processing program which causes a computer to execute:
a taken image input step of inputting a taken image in which face portions of persons are recorded;
a detection step of detecting the face portions of persons;
a face selection step of accepting selection of desired face portions from among the detected face portions;
an extraction step of extracting face images, which are images of the selected face portions, from the taken image;
a template image input step of inputting a template image having composite areas, which are space areas where the extracted face images are to be laid out; and
a composite step of laying out the extracted face images on the composite areas of the template image and creating a composite image in which the face images laid out on the composite areas are superimposed on the template image.

12. An image processing apparatus, comprising:
a taken image input section which inputs a taken image in which face portions of multiple persons are recorded;
a detection section which detects the face portions of persons;
an extraction section which extracts face images, which are images of the face portions of persons, from the taken image;
a layer-for-facial-composite input section which inputs layers for facial composite in which an image for composite having composite areas where the face images are to be superimposed is laid out; and
a creation section which creates a template image having composite areas of the number corresponding to the total number of the face images by overlapping a part or all of the layers for facial composite.

13. The image processing apparatus according to claim 12, wherein the creation section creates a template image by overlapping a background layer in which a background image is laid out with the layers for facial composite as a layer lower than the layers for facial composite.

14. The image processing apparatus according to claim 13, wherein the creation section lays out and overlaps, in accordance with information which specifies positions where the layers for facial composite are to be laid out on the background layer, the layers for facial composite on the specified positions on the background layer.

15. The image processing apparatus according to claim 13, wherein the creation section scales up/down the layers for facial composite in accordance with information which specifies the size of the layers for facial composite.

16. The image processing apparatus according to claim 14, wherein the creation section scales up/down the layers for facial composite in accordance with information which specifies the size of the layers for facial composite.

17. The image processing apparatus according to claim 12, further comprising a composite section which lays out the face images on the composite areas of the template image and superimposes the face images laid out on the composite areas on the template image.

18. An image processing method, comprising:
a taken image input step of inputting a taken image in which face portions of multiple persons are recorded;
a detection step of detecting the face portions of persons;
an extraction step of extracting face images, which are images of the face portions of persons, from the taken image;
a layer-for-facial-composite input step of inputting layers for facial composite in which an image for composite having composite areas where the face images are to be superimposed is laid out; and
a creation step of creating a template image having composite areas of the number corresponding to the total number of the face images by overlapping a part or all of the layers for facial composite.

19. An image processing program which causes a computer to execute:
a taken image input step of inputting a taken image in which face portions of multiple persons are recorded;
a detection step of detecting the face portions of persons;
an extraction step of extracting face images, which are images of the face portions of persons, from the taken image;
a layer-for-facial-composite input step of inputting layers for facial composite in which an image for composite having composite areas where the face images are to be superimposed is laid out; and
a creation step of creating a template image having composite areas of the number corresponding to the total number of the face images by overlapping a part or all of the layers for facial composite.
